(19) United States
(12) Patent Application Publication
(10) Pub. No.: US 2015/0162858 A1
(43) Pub. Date: Jun. 11, 2015

(54) MOTOR CONTROL APPARATUS AND MOTOR CONTROL METHOD

(71) Applicant: FUJITSU LIMITED, Kawasaki-shi (JP)

(72) Inventor: EIJI WAJIMA, Ebina (JP)

(21) Appl. No.: 14/554,100

(22) Filed: Nov. 26, 2014

(30) Foreign Application Priority Data
Dec. 6, 2013 (JP) 2013-252778

(51) Int. Cl. H02P 6/04

(52) U.S. Cl. CPC H02P 6/04; H02P 2006/045

(57) ABSTRACT

A motor control apparatus that controls a plurality of motors each including a plurality of coils, has a plurality of coil current driving signal generation apparatuses each provided for a corresponding one of control-target controlled motors of the plurality of motors to generate, at a first time interval, a plurality of coil current driving signals supplied to the plurality of coils in the controlled motor. Each of the plurality of coil current driving signal generation apparatuses includes: a timing state generation unit that cyclically generates a plurality of timing states at a period of a second time, which is shorter than the first time interval; and a coil current driving signal output unit that outputs the plurality of coil current driving signals to the controlled motor at a timing when the timing state generated by the timing state generation unit matches an assigned timing state assigned to the controlled motor.

### CROSS-REFERENCE TO RELATED APPLICATION

This application is based upon and claims the benefit of priority of the prior Japanese Patent Application No. 2013-252778, filed on Dec. 6, 2013, the entire contents of which are incorporated herein by reference.

### FIELD

The present invention relates to a motor control apparatus and a motor control method.

### BACKGROUND

An information apparatus such as a server incorporates a plurality of fans and motors that rotationally drive the respective plurality of fans, to emit heat generated in the apparatus. Moreover, the information processing apparatus has a motor control apparatus that controls a plurality of motors.

The motor control apparatus has coil current driving signal generating apparatuses each provided for a corresponding one of the plurality of motors to generate a plurality of coil current driving signals supplied to a plurality of coils in a controlled motor.

A fan current—a current consumed by a fan—is a coil current consumed by a plurality of coils in a motor for a fan in response to the coil current driving signal. For example, Japanese Patent Application Laid-open No. 2009-23166 indicates that the maximum current is suppressed by generating fan currents for a plurality of fans at different timings. However, Japanese Patent Application Laid-open No. 2009-23166 fails to refer to a peak current that is a coil inrush current.

### SUMMARY

An information processing apparatus with a plurality of fan motors has a power supply apparatus that supplies power to the plurality of motors. On the other hand, each of the motors consumes the coil current at the timing of the coil current driving signal supplied by the motor control apparatus provided for the motor. Moreover, when a current starts to be fed through the coil, a peak current is generated which is a short-time coil inrush current. The power supply apparatus supplies the motors for the plurality of fans with the respective coil currents, and thus, the maximum value of the total current for the plurality of fans is desirably suppressed in order to allow the power supply apparatus to be miniaturized. This is because allowing suppression of the maximum current value of the total current enables a reduction in the sizes of an inductor, a capacitor, and a switching element in the power supply apparatus, leading to a reduction in the size of the power supply apparatus.

However, the motor control apparatus provided for each motor outputs the coil current driving signal to the controlled motor at the motor control apparatus's own timing. As a result, start timings for the coil currents consumed by the coils in the plurality of motors may happen to match. Consequently, the current supply capability of the power supply apparatus needs to be designed assuming that the start timings for the coil currents may happen to match. The total current increases in proportion to an increase in the number of built-in fans, leading to the tendency that the power supply apparatus increases in size.

In particular, when the coil current has a peak current (coil inrush current) generated in a short time when the coil current starts to be generated, the capacity of the power supply apparatus needs to be designed based on the total current value of the peak currents in the plurality of motors assuming that generation timings for the peak currents happen to match. This results in an unavoidable increase in the size of the power supply apparatus.

One aspect of the embodiment is a motor control apparatus that controls a plurality of motors each including a plurality of coils, having a plurality of coil current driving signal generation apparatuses each provided for a corresponding one of control-target controlled motors of the plurality of motors to generate, at a first time interval, a plurality of coil current driving signals supplied to the plurality of coils in the controlled motor, wherein each of the plurality of coil current driving signal generation apparatuses includes: a timing state generation unit that cyclically generates a plurality of timing states at a period of a second time (T2), which is shorter than the first time interval; and a coil current driving signal output unit that outputs the plurality of coil current driving signals to the controlled motor at a timing when the timing state generated by the timing state generation unit matches an assigned timing state assigned to the controlled motor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of a configuration of a fan and a motor that drives the fan.

FIG. 2 is a view illustrating a circuit for the coil and the relations between coil circuits and the coil current driving signals DRV-A, DRV-B, DRV-C, and DRV-D.

FIG. 3 is a timing waveform diagram of the coil current driving signals and coil currents.

FIG. 4 is a diagram illustrating a fan total current obtained when timings for a plurality of fan currents completely match.

FIG. 5 is a diagram illustrating the peak current of the fan current.

FIG. 6 is a diagram illustrating timing control for the fan current according to an embodiment.

FIG. 7A and FIG. 7B are diagrams illustrating a configuration of a plurality of fans and fan control apparatuses in the information processing apparatus according to the embodiment.

FIG. 8 is another diagram illustrating the configuration of the plurality of fans and the fan control apparatuses in the information processing apparatus according to the embodiment.

FIG. 9 is a diagram of a configuration of the fan in FIG. 8.

FIG. 10 is a diagram illustrating an example of a configuration of the additional motor control circuit 10-2 according to the embodiment.

FIG. 11 to FIG. 12B are diagrams illustrating operations of the additional motor control circuit 10-2 according to the embodiment.

FIG. 13 is a first flowchart of a control program in the additional motor control circuit 10-2.

FIG. 14 and FIG. 15 are signal timing diagrams based on the first flowchart in FIG. 13.

FIG. 16 is a second flowchart of a control program in the additional motor control circuit 10-2.

FIG. 17 and FIG. 18 are signal timing diagrams based on the second flowchart in FIG. 16.

FIG. 19A to FIG. 20 are diagrams illustrating a synchronization operation performed by the system control unit 30 (FIG. 7A to FIG. 8) in the control unit 2-0 according to the embodiment using the synchronous signal C-sig.

FIG. 21 is a diagram illustrating an operation performed by the control units 3-0 to 3-7 using the timing state setting signal T-sig according to the embodiment.

FIG. 22A to FIG. 22C are diagrams illustrating examples of a method for setting the timing state setting signal T-sig for the additional motor control circuit 10-2.

FIG. 23 is a diagram illustrating an example of a method for inputting the synchronous signal C-sig to the additional motor control circuit 10-2 and setting the timing state setting signal T-sig.

FIG. 24 is a diagram illustrating the fan current provided by the motor control apparatus according to the embodiment.

FIG. 25 is a circuit diagram of the additional motor control circuit 10-2 according to a second embodiment.

FIG. 26 is a timing chart illustrating an operation of an additional motor control circuit 10-2.

### DESCRIPTION OF EMBODIMENTS

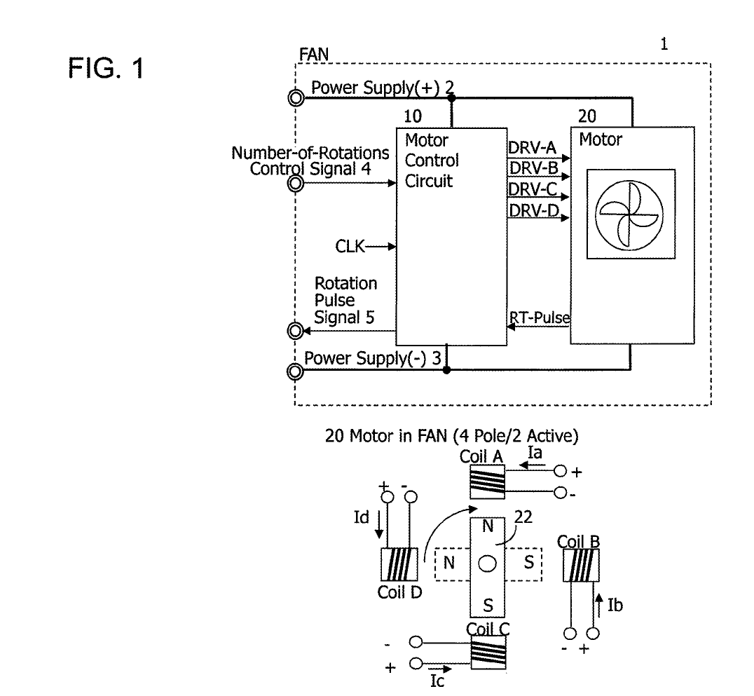

FIG. 1 is a diagram of a configuration of a fan and a motor that drives the fan. A fan 1 has a positive power supply 2, a negative power supply 3, a motor control circuit 10 provided between the power supplies 2 and 3, and a motor 20 controlled by the motor control circuit 10. The motor 20 is provided with a fan. The motor control circuit 10 receives a number-of-rotations control signal such as a pulse width modulation (PWM) control signal from a higher system not illustrated in the drawings, and outputs, for example, coil current driving signals DRV-A, DRV-B, DRV-C, and DRV-D, by which the motor 20 rotates with the number of rotations implemented by the control of the number-of-rotations control signal. A plurality of coils in the motor 20 is supplied with current at the timings of the coil current driving signals. The motor is rotated at the number of rotations based on the coil current driving signals. The motor 20 encodes the rotation of the motor to generate a rotation pulse signal RT-Pulse and outputs the rotation pulse signal RT-Pulse to the motor control circuit 10. The motor control circuit 10 amplifies the rotation pulse signal RT-Pulse and outputs a rotation pulse signal 5 to a higher system. Based on the number of rotations fed back by the rotation pulse signal 5, the higher system generates a number-of-rotations control signal 4.

FIG. 1 includes in the lower section thereof a diagram of a configuration of the motor 20 inside the fan. The motor 20 is an example of a four-pole two-active DC motor and has a first pair of coils A and C and a second pair of coils B and D, and a rotor 22.

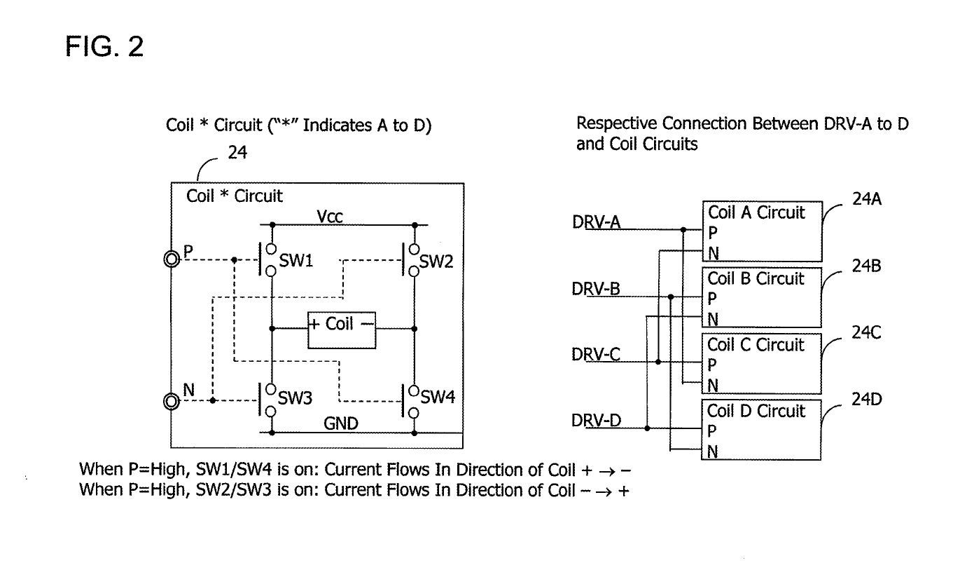

FIG. 2 is a view illustrating a circuit for the coil and the relations between coil circuits and the coil current driving signals DRV-A, DRV-B, DRV-C, and DRV-D. A coil circuit 24 has, for one coil, four switches SW1 to SW4 between a positive power supply Vcc and a negative power supply GND. The switches are made electrically conductive or non-conductive based on the four-phase coil current driving signals DRV-A, DRV-B, DRV-C, and DRV-D input to a P-pole terminal P and an N-pole terminal N.

Of four coil circuits 24A to 24D, a first pair of coils 24A and 24C receives the pair of coil current driving signals DRV-A and DRV-C so that the coils have opposite polarities. Similarly, a second pair of coils 24B and 24D receives the pair of coil current driving signals DRV-B and DRV-D so that the coils have opposite polarities.

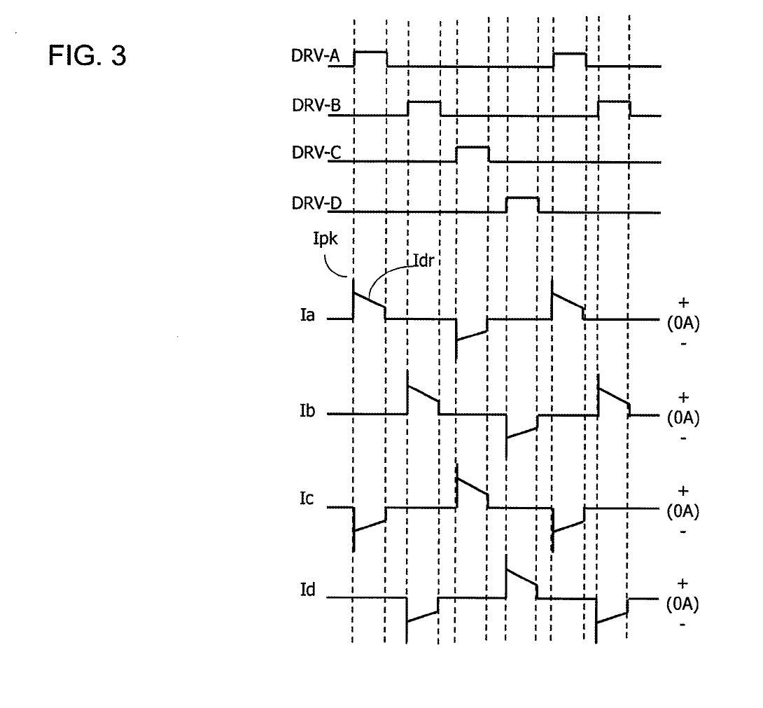

FIG. 3 is a timing waveform diagram of the coil current driving signals and coil currents. As illustrated in FIG. 3, when the first-phase coil current driving signal DRV-A is at an H level, coil currents Ia and Ic with opposite polarities are generated in the coil circuits 24A and 24C. Then, when the second-phase coil current driving signal DRV-B is at the H level, coil currents Ib and Id with opposite polarities are generated in the coil circuits 24B and 24D. Moreover, when the third-phase coil current driving signal DRV-C is at the H level, coil currents Ia and Ic with opposite polarities that are opposite to the polarities in the first phase are generated in the coil circuits 24A and 24C. When the fourth-phase coil current driving signal DRV-D is at the H level, coil currents Ib and Id with opposite polarities that are opposite to the polarities in the second phase are generated in the coil circuits 24B and 24D. Thus, the direction of magnetism in the motor illustrated in FIG. 1 rotates to rotate the rotor 22.

As illustrated in FIG. 3, each of the coil currents Ia, Ib, Ic, and Id has a peak current Ipk generated when the corresponding one of the coil current driving signals DRV-A, DRV-B, DRV-C, and DRV-D starts pulsing, and a subsequent driving current Idr. At the moment when the coil current switches SW-1 to SW-4 are made electrically conductive, the coil offers small resistance and thus generates a short-time peak current Ipk. However, subsequently, a magnetic field is generated in the coil to reduce the coil current as a result of the induction action of the magnetic field. The coil driving current Idr allows a magnetic field to be generated in the coil to rotate a rotor in the motor.

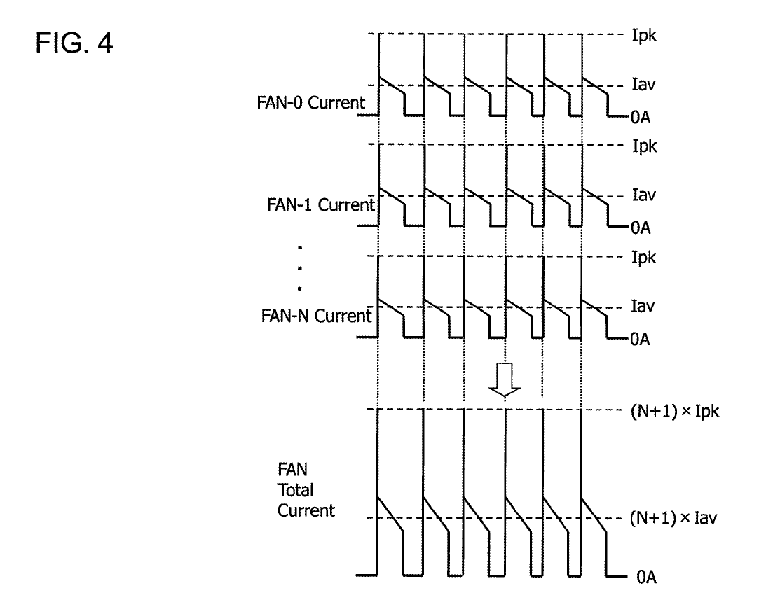

FIG. 4 is a diagram illustrating a fan total current obtained when timings for a plurality of fan currents completely match. FIG. 4 illustrates total coil currents (fan currents) for N+1 fans FAN-0, FAN-1, . . . , FAN-N and the fan total current of the fan currents.

The total current of the four coil currents in one fan illustrated in FIG. 3 is each of the fan currents illustrated in FIG. 4. Thus, the peak current Ipk of the fan current in FIG. 4 is double the peak current Ipk in FIG. 3. Furthermore, FIG. 4 illustrates the average current My of the fan current.

As illustrated in FIG. 4, when the timings for (phases of) the N+1 sets the coil current driving signals DRV-A, DRV-B, DRV-C, and DRV-D input to the N+1 fans, respectively, completely match, the timings for the N+1 fan currents match. The peak current of the fan total current is equal to the peak current Ipk of each fan current multiplied by N+1. The average current of the fan total current is equal to the average current My of each fan current multiplied by N+1. The peak current of the fan total current, equal to each fan current multiplied by N+1, has a large current value, and thus, a power supply apparatus designed based on the peak current of the fan total current has an increased size. Therefore, the power supply apparatus can be miniaturized by enabling the generation timings for the peak currents Ipk in the fans to be shifted.

On the other hand, the four-phase coil current driving signals DRV-A, DRV-B, DRV-C, and DRV-D generate pulses in order at a period associated with high-speed rotation of the fan. Thus, the average current of the fan total current cannot be reduced even by varying the transmission of the four-phase coil current driving signals to the motors of the fans.

In other words, for an information processing apparatus with a plurality of fans mounted therein, when a power supply apparatus for fan power supply is designed, it is not ensured that the plurality of fan currents can avoid overlapping because the plurality of fans operate at the respective independent timings. Thus, the average current value of the total fan current of the plurality of fan currents is only (N+1)×Iav, but the output capacity of the power supply apparatus needs to be designed with the expectation that the maximum current value of the power supply apparatus is equal to (N+1)×the peak current Ipk. A significant difference is present between the peak current Ipk and average current My of the fan current , and thus, the power supply apparatus needs to have a large output capacity with respect to the effective power consumption values of the plurality of fans.

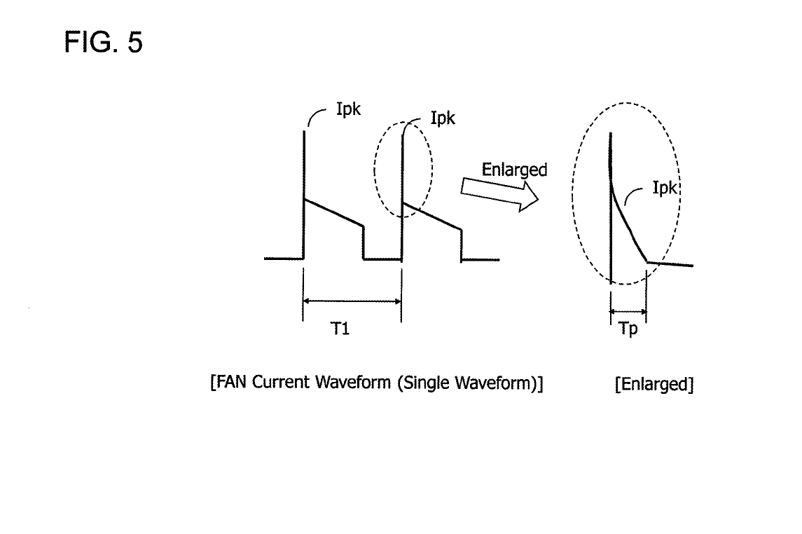

FIG. 5 is a diagram illustrating the peak current of the fan current. FIG. 5 illustrates the waveform of the fan current for one fan and the enlarged waveform of the peak current Ipk of the fan current. Time intervals T1 at which the fan current is generated are equal to intervals for the coil current driving signals DRV-A, DRV-B, DRV-C, and DRV-D. A duration Tp for which the peak current Ipk is generated is very small with respect to the time interval T1.

A specific example will be described. When the rotation speed of the fan is assumed to be up to 15,000 rpm (250 rotations/sec), the time interval T1 for the fan current is tb=1.0 ms because the four-phase coil current driving signals allows the fan current to be generated. On the other hand, the duration Tp of the peak current of the fan current is generally about 10 μs. In other words, the interval T1 of the fan current is at least about 100 times as long as the duration Tp of the peak current. A reduced rotation speed of the fan makes the interval T1 100 times as long as the duration Tp or more.

Thus, to prevent the peak currents of the fan currents from overlapping, the start timings for the coil current driving signals supplied to the fans may be shifted so as not to overlap within a duration of at most 1/100 of the interval T1 of a drive signal. When one server apparatus is provided with eight fans, the start timings for the coil current driving signals may be distributed within about 8/100 of the interval T1 for the driving signals.

### Embodiment

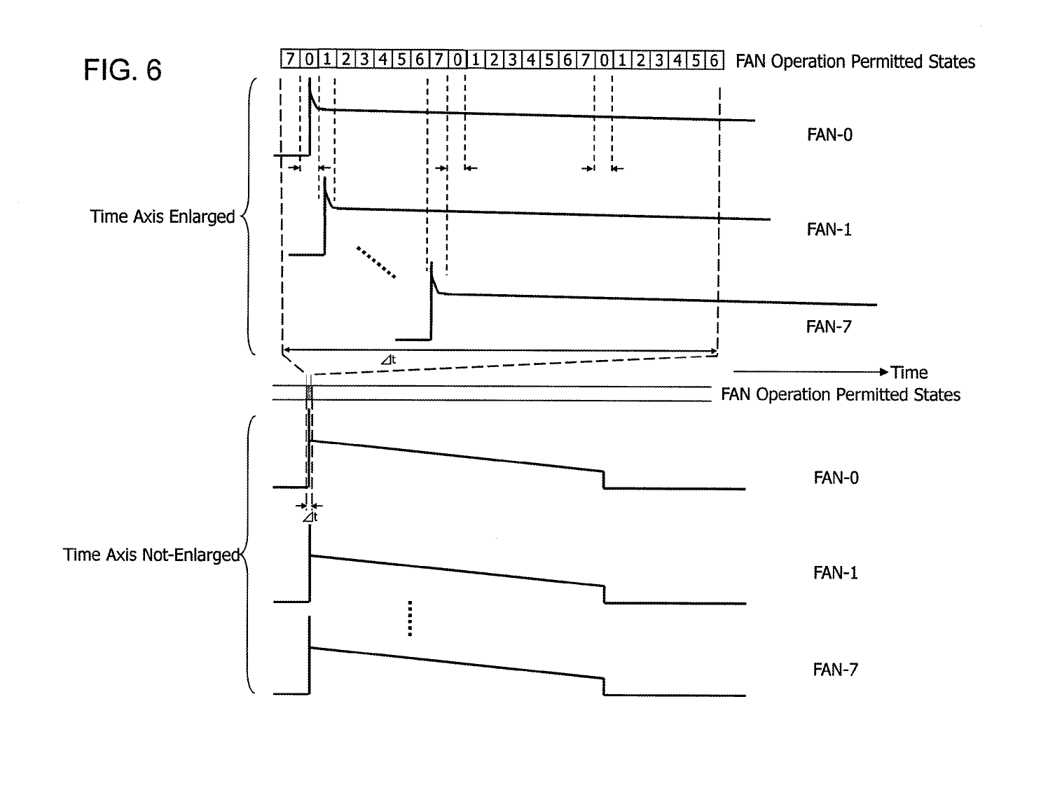

FIG. 6 is a diagram illustrating timing control for the fan current according to an embodiment. FIG. 6 illustrates the lower waveforms of the currents in the three fans FAN-0, FAN-1, FAN-8 of eight fans with the time axis on the axis of abscissas not enlarged, and the upper waveforms of the currents in the three fans FAN-0, FAN-1, FAN-8 with the time axis on the axis of abscissas enlarged. The upper waveforms result from enlargement of time At for the lower waveforms.

In the embodiment, the motor control circuit controlling the motor for each fan controls the start timings for the coil current driving signals so as to generate a plurality of (for example, eight) timing states (fan operation permitted states) that circulate at a period sufficiently shorter than the driving interval T1 for the fan currents so that the peak currents in the eight fans are generated in timing states differently assigned to the respective motors. That is, for the fan FAN-0, the fan current starts to be generated at a timing when the timing state is “0”. For the fan FAN-1, the fan current starts to be generated at a timing when the timing state is “1”. For the fans FAN-2 to FAN-6, the fan current starts to be generated at a timing when the timing state is one of the values “2” to “6”, respectively. For the fan FAN-7, the fan current starts to be generated at a timing when the timing state is “7”.

As described with reference to FIG. 5, the generation time Tp for the peak current Ipk of the fan current is very short as shown by the fan currents with the time axis enlarged in FIG. 6. Thus, even when the generation timings for the peak currents Ipk are distributed among the eight timing states, only a short time difference occurs among the generation timings for the fan currents as shown by the fan currents with the time axis non-enlarged in FIG. 6.

Furthermore, according to the embodiment, when the motor control circuits controlling the motors for the fans generate timing states State in synchronism with the respective clocks, it is expected that the timing states State for the motors for the plurality of fans are asynchronously shifted, for example, the timing states “1” and “3” simultaneously occur among the different fans. Thus, the timing states in the motor control circuits are desirably synchronized with one another using a single synchronous signal.

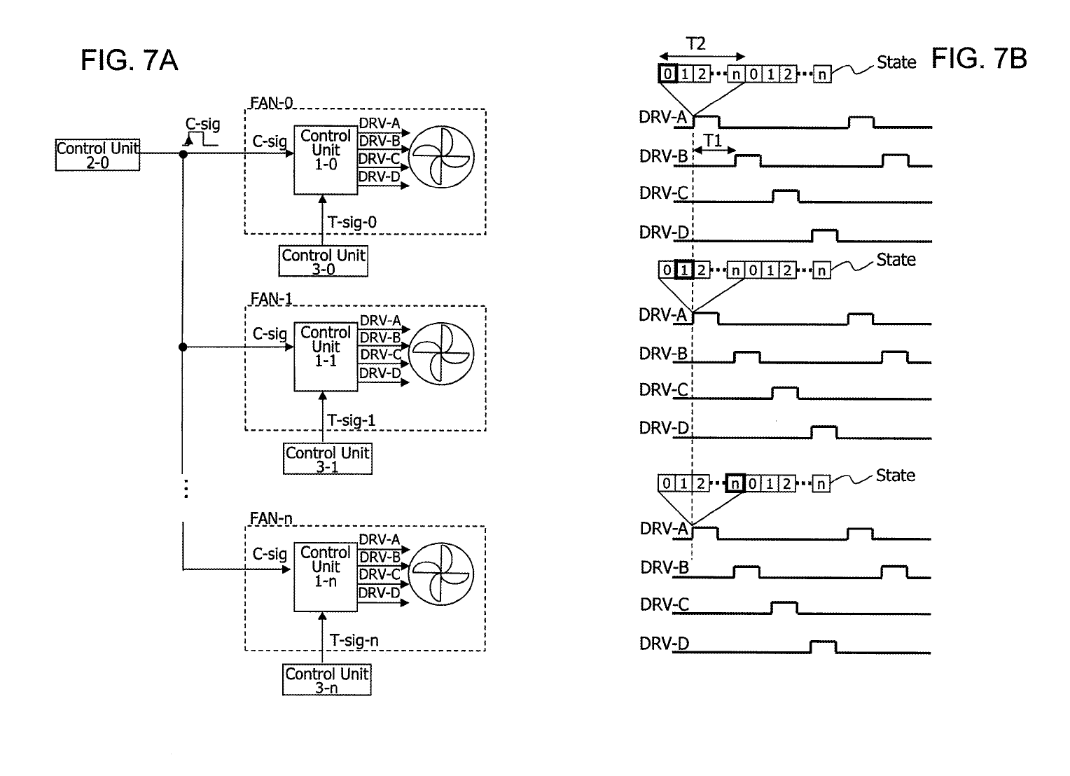

FIG. 7A and FIG. 7B are diagrams illustrating a configuration of a plurality of fans and fan control apparatuses in the information processing apparatus according to the embodiment. FIG. 7A illustrates the configuration of the plurality of fans and the fan control apparatuses, and FIG. 7B illustrates pulse generation timings for the coil current driving signals DRV-A, DRV-B, DRV-C, and DRV-D output by the fan control apparatuses.

As illustrated in FIG. 7A, a plurality of fans FAN-0 to FAN-n have respective fans, respective control units 1-0 to 1-n that are the motor control circuits 10 (see FIG. 1) controlling the motors for the fans, and respective control units 3-0 to 3-n that set timing states T-sig-0 to T-sig-n for the control units 1-0 to 1-n. Furthermore, as the motor control apparatus, a control unit 2-0 is provided which outputs a synchronous signal C-sig to the plurality of fans FAN-0 to FAN-n. One of the control units 1-0 to 1-n and one of the control units 3-0 to 3-n correspond to the motor control circuit provided for each fan.

As illustrated in FIG. 7B, the control units 1-0 to 1-n for the respective fans each cyclically generate a plurality of timing states State at a period of time T2 shorter than the time interval T1 for the coil current driving signals DRV-A, DRV-B, DRV-C, and DRV-D. The control units 1-0 to 1-n for the respective fans each output the pulse of the corresponding one of the coil current driving signals DRV-A, DRV-B, DRV-C, and DRV-D at such a timing when the cyclically generated timing state matches a set timing states set by the corresponding one of the timing state setting signals T-sig-0 to T-sig-n.

In the example in FIG. 7A and FIG. 7B, the timing states 0 to n are assigned to the n fans FAN-0 to FAN-n, respectively, as illustrated by thick-frame timing states State in FIG. 7B. Thus, the control units 1-0 to 1-n for the n+1 fans output the pulse of the corresponding one of the coil current driving signals DRV-A, DRV-B, DRV-C, and DRV-D in the respective timing states 0 to n. As a result, as described with reference to FIG. 6, the peak current, that is generated when the coil current starts rushing into the coil as a result of the pulse of the coil current driving signal, is generated at different timings among the motors for the n+1 fans. Thus, the peak current of the total motor current can be kept low.

Furthermore, when the control units 1-0 to 1-n for the n+1 fans FAN-0 to FAN-n cyclically generate timing states State in synchronism with the respective clocks, the timing states are asynchronously generated due to a clock frequency deviation among the n+1 fans. In that case, the control unit 2-0 outputs the synchronous signal C-sig to the control units 1-0 to 1-n regularly or irregularly but before the timing states State of respective n+1 fans are shifted to an unacceptable degree. Each of the control units 1-0 to 1-n of each fan resets the timing states State cyclically generated by the control unit, in synchronism with the synchronous signal C-sig. This prevents the timing states State provided by the control units 1-0 to 1-n from being shifted to an unacceptable degree, leading to overlapping of the peak currents in the fans.

When the control units 1-0 to 1-n for the n+1 fans FAN-0 to FAN-n cyclically generate timing states State in synchronism with a single clock, the synchronous signal C-sig need not be supplied for synchronization.

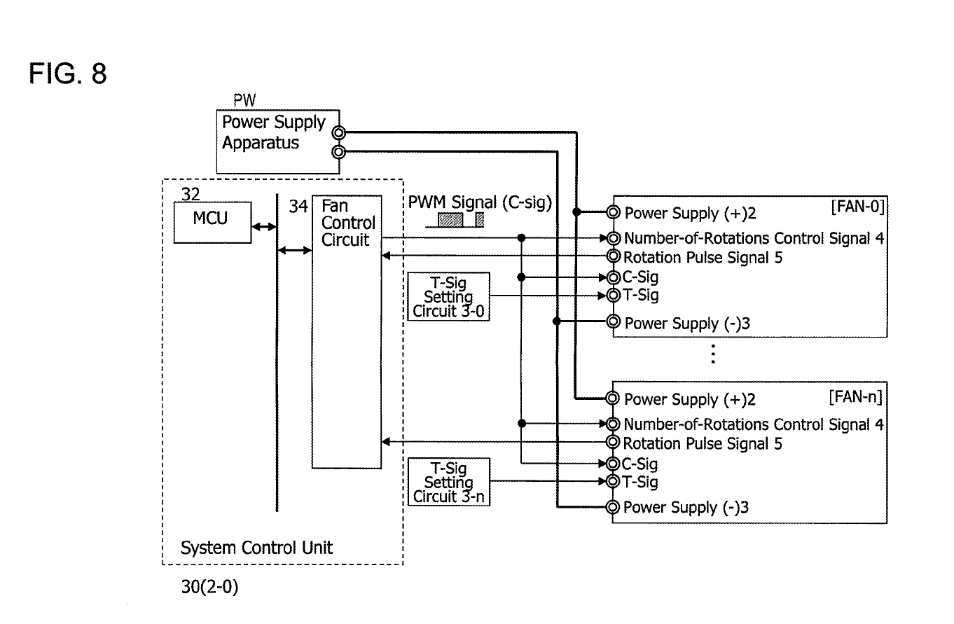

FIG. 8 is another diagram illustrating the configuration of the plurality of fans and the fan control apparatuses in the information processing apparatus according to the embodiment. Unlike in FIG. 7A and FIG. 7B, the power supplies 2 and 3, the number-of-rotations control signal 4, the number-of-rotations pulse signal 5, the synchronous signal C-sig, and the timing state setting signal T-sig are illustrated in each of the n+1 fans FAN-0 to FAN-n. Furthermore, unlike in FIG. 7A and FIG. 7B, a system control unit 30 is illustrated as the control unit 2-0. The system control unit 30 internally has a microcomputer unit (MCU) 32 and a fan control circuit 34, and generates a PWM signal as the number-of-rotations control signal 4 to output the PWM signal to the control units 1-0 to 1-n (not illustrated in the drawings) in the fans. The PWM signal is generated at every given period to control the number of rotations based on the duty ratio of pulses. Thus, in the example in FIG. 8, the pulse signal of the PWM signal, the number-of-rotations control signal 4, is utilized as the synchronous signal C-sig. Moreover, unlike in FIG. 7A and FIG. 7B, a power supply apparatus PW provides the power supplies 2 and 3 to each of the fans to supply needed coil currents.

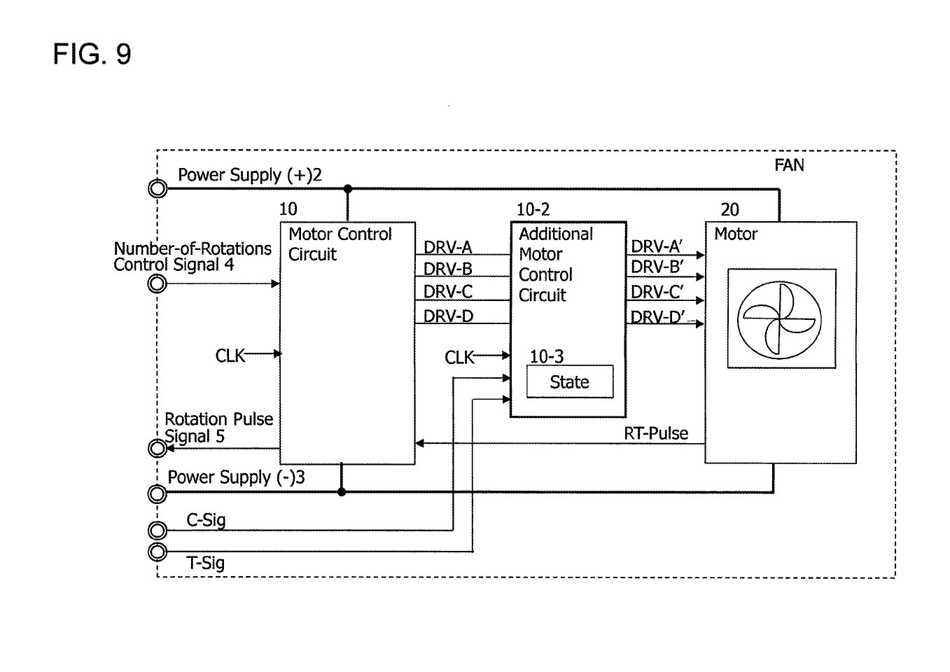

FIG. 9 is a diagram of a configuration of the fan in FIG. 8. The fan illustrated in FIG. 9 has the motor 20 that rotates the fan and the motor control circuit 10 as in the case of FIG. 1. Moreover, the fan illustrated in FIG. 9 has an additional motor control circuit 10-2 besides the motor control circuit 10, and both circuits 10 and 10-2 correspond to the control unit 1-k (k=0 to n) in FIG. 7A and FIG. 7B. Thus, the motor control circuit 10 and the motor control circuit 10-2 provide a motor control circuit that controls the motor 20.

In this motor control circuit, the motor control circuit 10 generates, on the basis of the number-of-rotations control signal 4 of the system control unit 30, coil current driving signals DRV-A, DRV-B, DRV-C, and DRV-D at the time intervals T1 corresponding to the desired number of rotations. Moreover, the motor control circuit 10-2 outputs each of adjusted coil current driving signals DRV-A′, DRV-B′, DRV-C′, and DRV-D′ to the coils in the motor 20 at a timing when a timing state generated by a built-in timing state generation unit 10-3 matches a timing state set by the setting signal T-sig. The motor control circuit 10 and the motor control unit 10-2 need not necessarily be separated from each other. However, in the embodiment, the motor control circuit 10 in FIG. 1 is additionally provided with the motor control circuit 10-2 in FIG. 9 so that the motor control circuit 10 generates the coil current driving signals DRV-A, DRV-B, DRV-C, and DRV-D and that the additional motor control circuit 10-2 adjusts the timing for the pulse of each of the coil current driving signals DRV-A, DRV-B, DRV-C, and DRV-D to the timing for the timing states State to output the adjusted coil current driving signals DRV-A′, DRV-B′, DRV-C′, and DRV-D′.

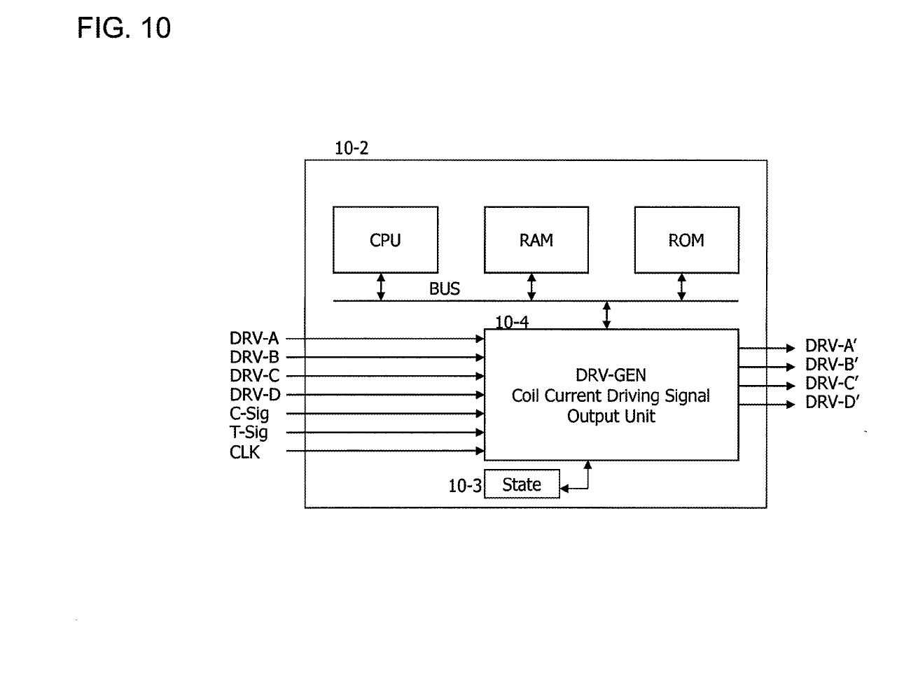

FIG. 10 is a diagram illustrating an example of a configuration of the additional motor control circuit 10-2 according to the embodiment. The motor control circuit 10-2 in FIG. 10 is a microcomputer having a coil current driving signal output unit 10-4, and has a CPU, a RAM, and a ROM. The timing state generation unit 10-3 and a coil current driving signal output unit 10-4 are partly or wholly implemented by the CPU by executing software in the ROM. However, the motor control circuit 10-2 may be provided using a dedicated hardware circuit. The dedicated hardware circuit will be described below.

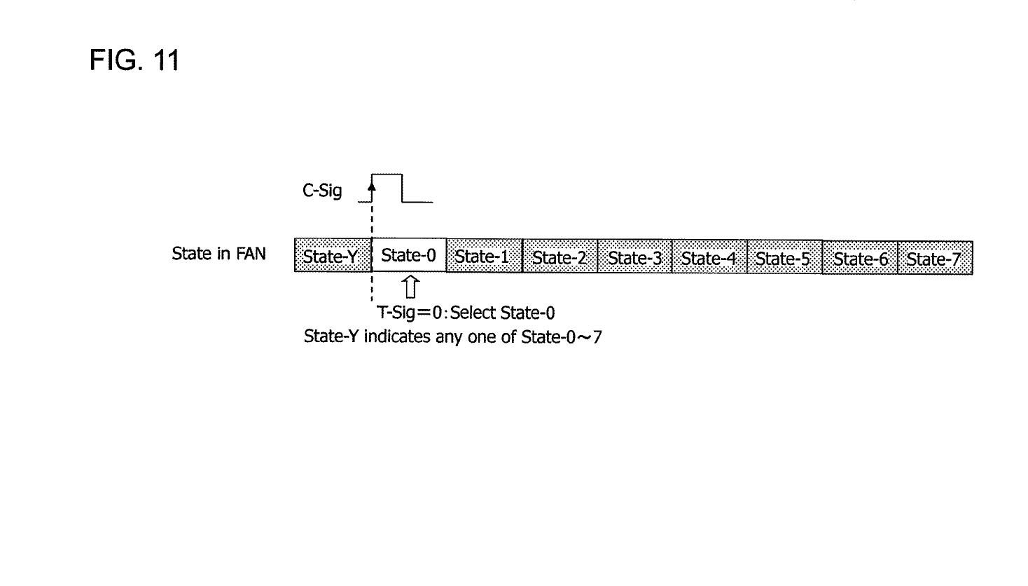

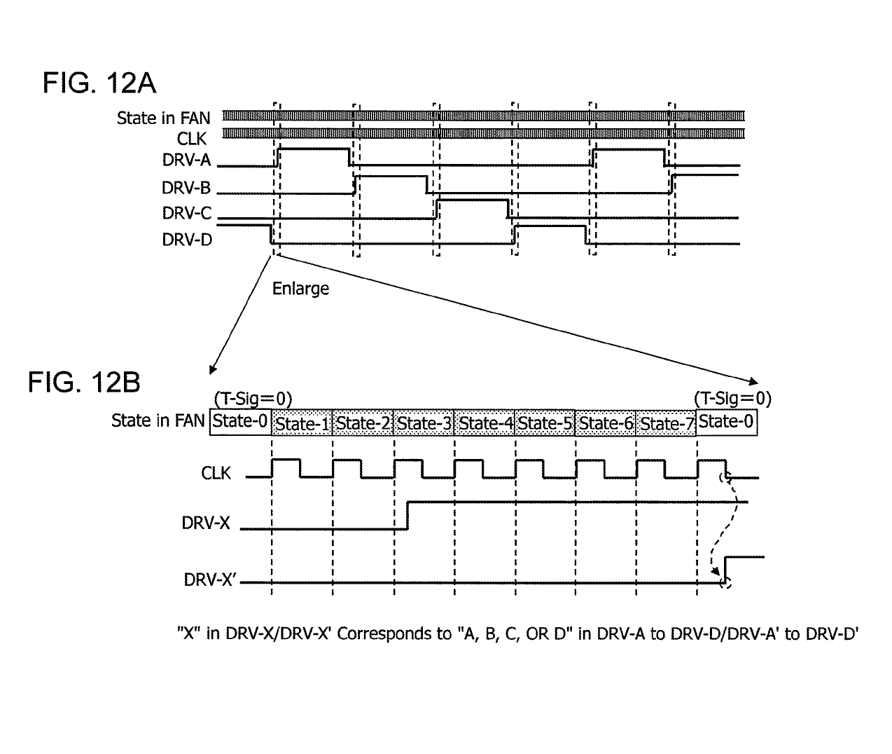

FIG. 11 to FIG. 12B are diagrams illustrating operations of the additional motor control circuit 10-2 according to the embodiment. In an example described below, the number of fans is eight. Thus, the plurality of fans illustrated in FIG. 7A and FIG. 7B are an example of fans FAN-0 to FAN-7 (n=7).

First, as illustrated in FIG. 11, the additional motor control circuit 10-2 has the timing state generation unit 10-3 that generates timing states State in the fan in synchronism with a clock CLK. Since the number of fans is eight, the timing state generation unit 10-3, incorporated in the additional motor control circuit 10-2 in each fan, cyclically generates timing states State from 0 to 7 in synchronism with the clock CLK for the fan. The additional motor control circuit 10-2 outputs each of the adjusted coil current driving signals DRV-A′, DRV-B′, DRV-C′, and DRV-D′ at the timing when the timing state generated in the fan matches the timing state (in the example in FIG. 11, State-0) set by the timing state setting signal T-sig.

When the clocks CLK for the respective fans are asynchronous, the timing states State of the plurality of fans are asynchronous among the fans. When the timing states State of the fans are misaligned with one another to an unacceptable degree, the generation timings for the peak currents in the fans fail to be distributed and may match accidentally. Thus, in synchronism with the synchronous signal C-sig common to the plurality of fans, the timing state generation unit 10-3 for each fan resets the timing state to State-0. FIG. 11 illustrates that the timing state is reset to State-0 in response to the synchronous signal C-sig received during a timing state-Y (Y is one of the values 0 to 7).

Second, as illustrated in FIG. 12A and FIG. 12B, the additional motor control circuit 10-2 shifts (delays) each of the coil current driving signals DRV-A, DRV-B, DRV-C, and DRV-D generated by the motor control circuit 10 to a timing when the internal timing state matches the timing state set by the setting signal T-sig, and outputs the corresponding one of the adjusted coil current driving signals DRV-A′, DRV-B′, DRV-C′, and DRV-D′.

FIG. 12A illustrates the coil current driving signals DRV-A, DRV-B, DRV-C, and DRV-D generated by the motor control circuit 10. FIG. 12B is an enlarged diagram of the time of a rising edge of one of the coil current driving signals DRV-A, DRV-B, DRV-C, and DRV-D. FIG. 12B illustrates the internal timing states State, the clock CLK, the coil current driving signals DRV-A, DRV-B, DRV-C, and DRV-D, and the adjusted coil current driving signals DRV-A′, DRV-B′, DRV-C′, and DRV-D′. FIG. 12B illustrates one of the four-phase coil current driving signals as DRV-X or DRV-X′.

As illustrated in FIG. 12A and FIG. 12B, the additional motor control circuit 10-2 delays the coil current driving signal DRV-X generated by the motor control circuit 10 until the timing of the set timing state-0, and outputs the adjusted coil current driving signal DRV-X′. Since the set timing state is State-0, this is an example of the fan FAN-0. For the fans FAN-1 to FAN-7, the set timing states are State-1 to State-7, respectively. As a result, the timing when the adjusted coil current driving signal DRV-X′ is output varies among all the fans.

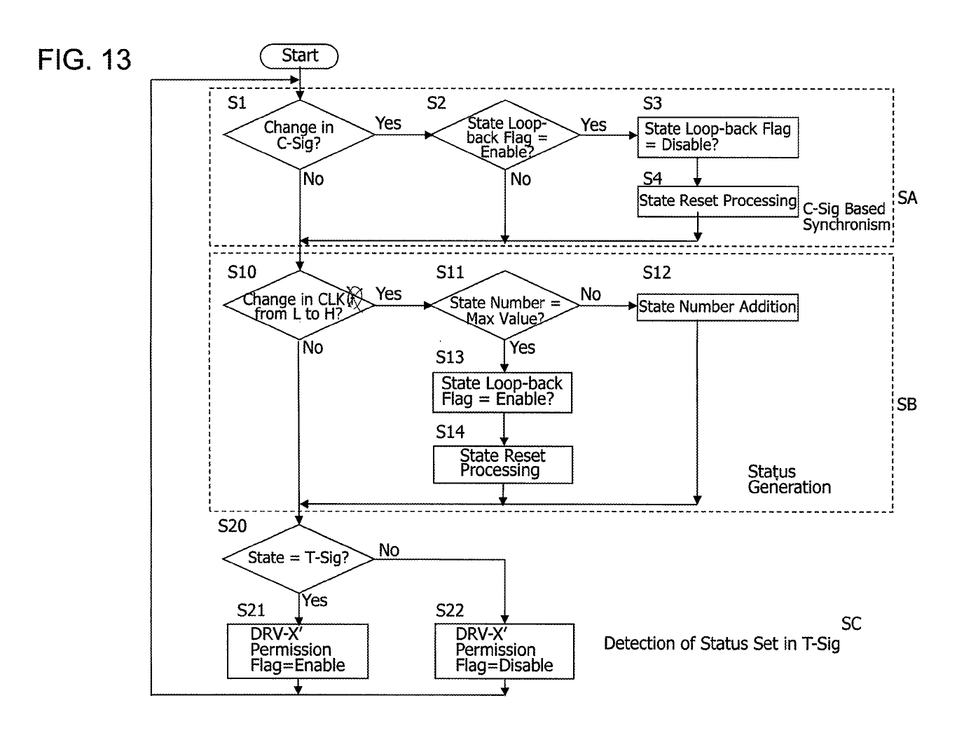

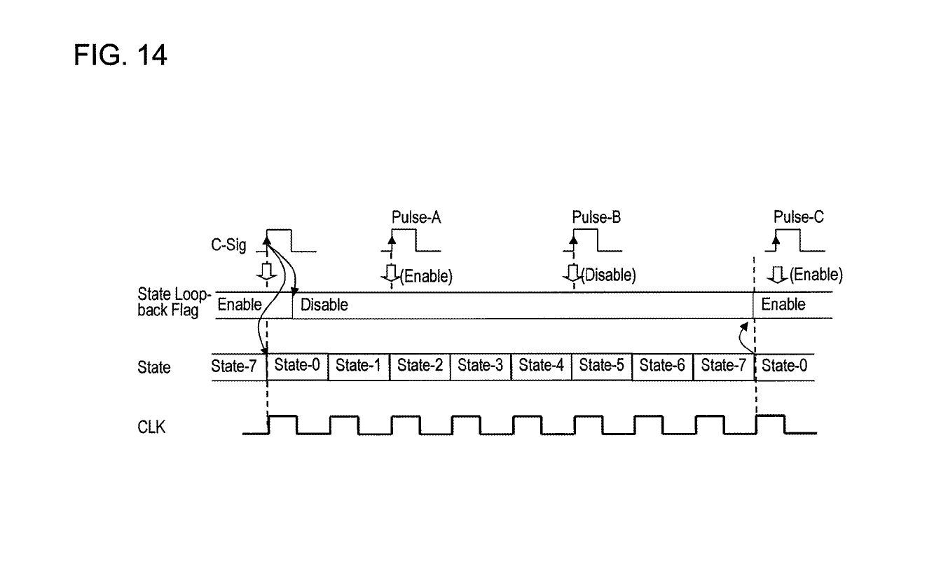

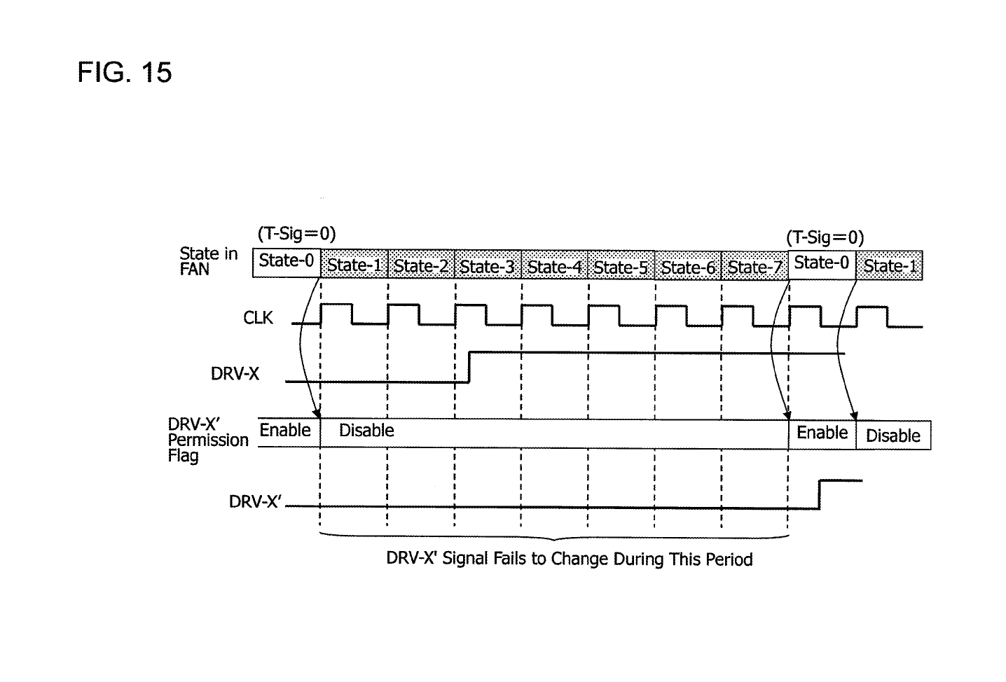

FIG. 13 is a first flowchart of a control program in the additional motor control circuit 10-2. FIG. 14 and FIG. 15 are signal timing diagrams based on the first flowchart in FIG. 13.

The first flowchart in FIG. 13 illustrates an operation SB performed by the timing state generation unit 10-3 built in the additional motor control circuit 10-2 to cyclically generate timing states State, a synchronization operation SA based on the synchronous signal C-sig, and a detection operation SC of detecting the timing state set by the timing state setting signal T-sig.

First, the timing state generation operation SB will be described with reference to FIG. 14. At a rising edge of the clock CLK (YES in S10), the additional motor control circuit 10-2 increments the timing state number by +1 (S12) while the state number is smaller than the maximum value (7) (NO in S11). Furthermore, at the rising edge of the clock CLK (YES in S10), the timing state is reset to the minimum value (0) (S14) when the state number becomes equal to the maximum value (7) (YES in S11). At this time, a state loop-back flag is enabled (S13). In other words, in the timing state generation operation SB, the timing state is incremented in order starting with the minimum value (0) in synchronism with the rising edge of the clock CLK, and upon reaching the maximum value (7), is reset to the minimum value (0) at the next clock cycle, as illustrated in FIG. 14.

Moreover, in the synchronization operation SA, when the synchronous signal C-sig changes (YES in S1), the additional motor control circuit 10-2 disables the state loop-back flag (S3), while simultaneously resetting the timing state to 0 (S4) if the state loop-back flag is enabled (YES in S2).

In the synchronization operation SA, when the synchronous signal C-sig changes while the state loop-back flag is enabled, the additional motor control circuit 10-2 forcibly resets the timing state to the minimum value (0), as illustrated in FIG. 14. However, after the timing state is reset in synchronism with a change in the synchronous signal C-sig, the reset operation is not performed even with a subsequent change in the synchronous signal C-sig until the timing state loops back to reach the maximum value (7). As illustrated in FIG. 14, resetting is not performed at a pulse Pulse-A or a pulse Pulse-B but is performed at a pulse Pulse-C. This is because the synchronous signal C-sig changes at a period sufficiently longer than the cyclic period T2 of the timing state generated by the timing state generation unit 10-3, so as to prevent the timing state from being frequently reset. Thus, the timing state is prevented from being reset by a possible change in the synchronous signal C-sig at an interval shorter than the cyclic period T2 as a result of any malfunction.

In the detection operation SC of detecting the set timing state in FIG. 13, the additional motor control circuit 10-2 enables a permission flag for the adjusted coil current driving signal DRV-X′ (S21) when the internal timing state matches the state set by the setting signal T-sig (YES in S20) and disables the permission flag (S22) when the internal timing state fails to match the state set by the setting signal T-sig (NO in S20), as illustrated in FIG. 15. Thus, as illustrated in FIG. 15, the additional motor control circuit 10-2 delays the coil current driving signal DRV-X input in the timing state=3 until the timing state (in FIG. 15, State-0) where the DRV-X′ permission flag is enabled in the subsequent set timing state-0, and then outputs the delayed coil current driving signal DRV-X′.

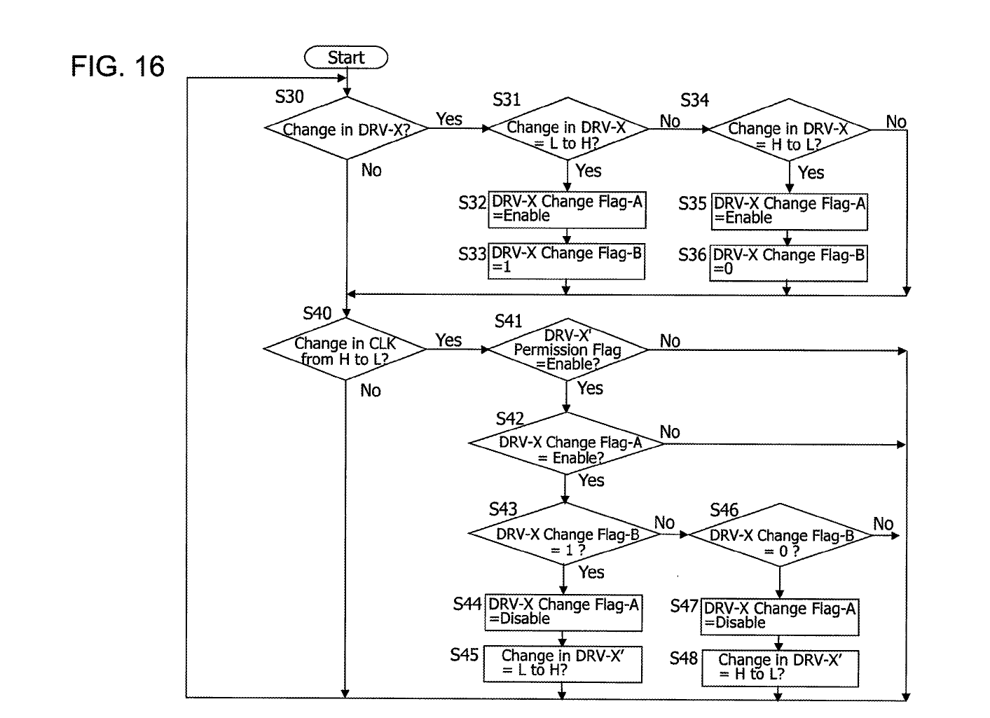

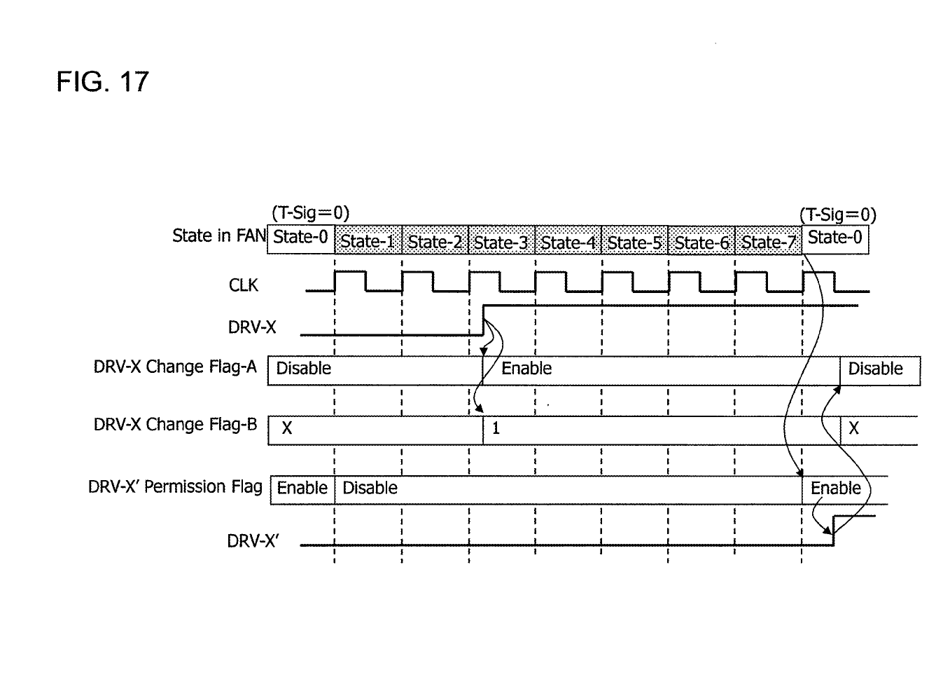

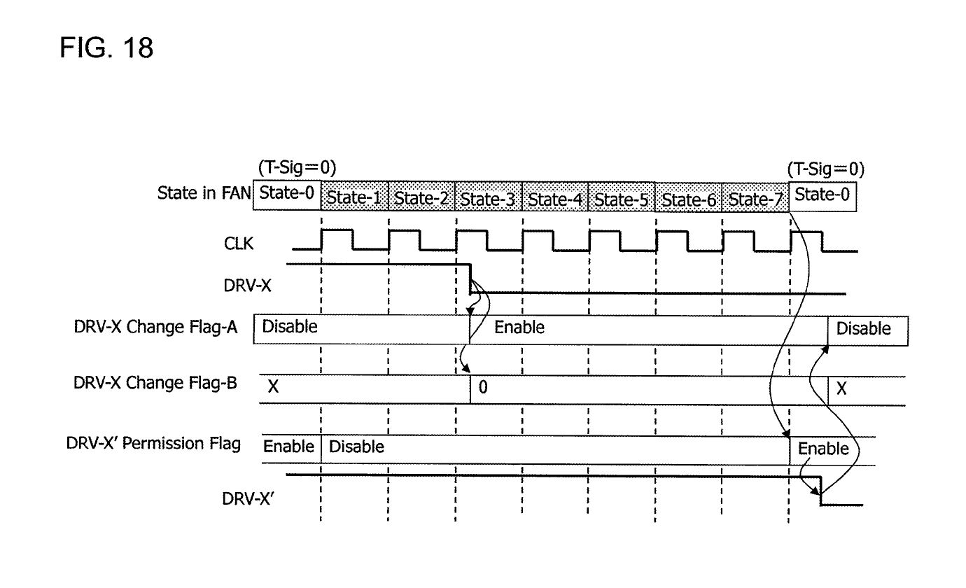

FIG. 16 is a second flowchart of a control program in the additional motor control circuit 10-2. Furthermore, FIG. 17 and FIG. 18 are signal timing diagrams based on the second flowchart in FIG. 16.

As illustrated in the second flowchart in FIG. 16, the additional motor control circuit 10-2 stores a change and the direction of the change of the input coil current driving signal DRV-X in DRV-X change flags A and B. The additional motor control circuit 10-2 then outputs the adjusted coil current driving signal DRV-X′ in synchronism with the falling edge of the clock CLK in the cycle of the timing state where the DRV-X′ permission flag is enabled. The adjusted coil current driving signal DRV-X′ is controlled to rise or fall based on the stored direction of the change in the coil current driving signal DRV-X.

FIG. 17 is a timing chart for a rise in the coil current driving signal DRV-X, and FIG. 18 is a timing chart for a fall in the coil current driving signal DRV-X. The rise and fall will be described with reference to FIG. 16. When the input coil current driving signal DRV-X changes (YES in S30), the additional motor control circuit 10-2 enables the DRV-X change flag A (S32 and S35). Furthermore, the additional motor control circuit 10-2 sets the DRV-X change flag B to “1” in response to a rise and to “0” in response to a fall (S33 and S36) in accordance with the direction of the change (a rise in S31 and a fall in S34). As illustrated in FIG. 17 and FIG. 18, the input coil current driving signal DRV-X changes at the timing of the timing state-3, with DRV-X change flags A and B stored.

Then, the additional motor control circuit 10-2 responds to a fall in the clock CLK (YES in S40). If the internal timing state matches the state set by the setting signal T-sig and the DRV-X′ permission flag is enabled (YES in S41), when the DRV-X change flag A is enabled (YES in S42), the additional motor control circuit 10-2 allows the adjusted coil current driving signal DRV-X′ to rise or fall (S45 or S48) depending on whether the DRV-X change flag B is “1” or “0” (S43 or S46), and then the DRV-X change flag A is turned to be disabled (S44 and S47). As illustrated in FIG. 17 and FIG. 18, in the cycle of the timing state-0, a rising edge or a falling edge of the adjusted coil current driving signal DRV-X′ is output in response to the falling edge of the clock CLK.

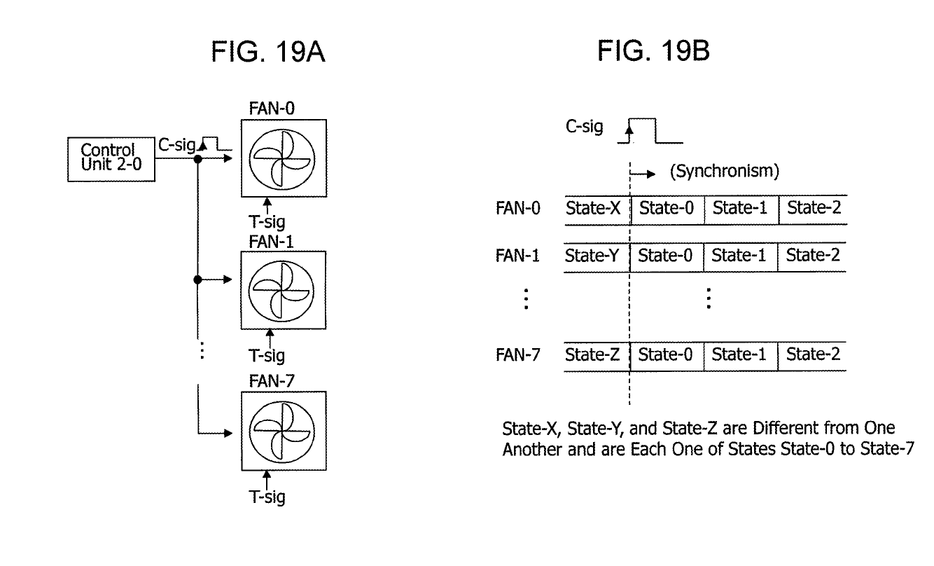

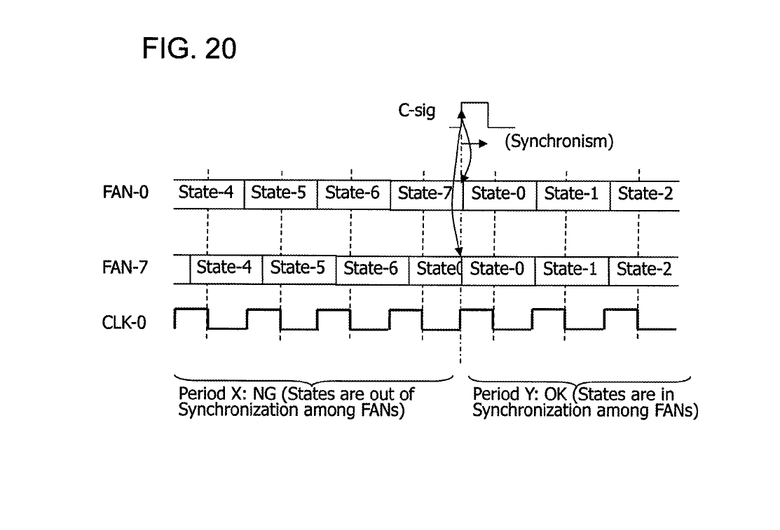

FIG. 19A to FIG. 20 are diagrams illustrating a synchronization operation performed by the system control unit 30 (FIG. 7A to FIG. 8) in the control unit 2-0 according to the embodiment using the synchronous signal C-sig. As illustrated in FIG. 19A, a common control unit 2-0 (system control unit 30) outputs the synchronous signal C-sig to the fans FAN-0 to FAN-7.

As illustrated in FIG. 19B, the timing states State inside the eight fans FAN-0 to FAN-7 are concurrently reset to the timing state-0 in response to the synchronous signal C-sig. In this example, the timing states inside the fans FAN-0, FAN-1, . . . , FAN-7 are State-X, State-Y, . . . , State-Z, respectively, and are thus different from one another but are concurrently reset to the timing state=0 in synchronism with the synchronous signal C-sig.

As illustrated in FIG. 20, the timing states State inside the fans FAN-0 and FAN-7 are reset in response to the synchronous signal C-sig. In the example in FIG. 20, the timing states State inside the fan FAN-0 are misaligned with the timing states State inside the fan FAN-7 on the time axis, with State-7 of the fan FAN-0 partly overlapping State-0 of the fan FAN-7. A longer overlapping time makes the timing of a rise in the adjusted coil current driving signal DRV-X′ for the fan FAN-0 temporally close to the timing of a rise in the adjusted coil current driving signal DRV-X′ for the fan FAN-7. As a result, the peak currents in both fans are expected to overlap, increasing the peak value of the total current. Thus, on account of the synchronous signal C-sig this problem can be prevented by resetting the internal timing states of both fans.

As illustrated in FIG. 20, the timing states of the fans are out of synchronization during a period X and are in synchronization during a period Y after resetting with the synchronous signal C-sig.

As described above, the purpose of the synchronous signal C-sig is to synchronize the timing states of the fans. Thus, after the synchronization with the synchronous signal C-sig, no subsequent synchronous signal C-sig needs to be generated until an elapsed time is reached at which the timing states State of the fans are assumed to be out of synchronization to an unacceptable degree due to a deviation among the clocks CLK inside the fans or a deviation among any other internal circuits. In other words, the period of the synchronous signal C-sig may be set at least to a time T3 sufficiently longer than the period T2 during which the timing states State circulate. As described above, if the generation timing for the PWM control signal that controls the number of fan rotations is appropriate for such a period, the control pulse of the PWM control signal may be utilized as the synchronous signal C-sig.

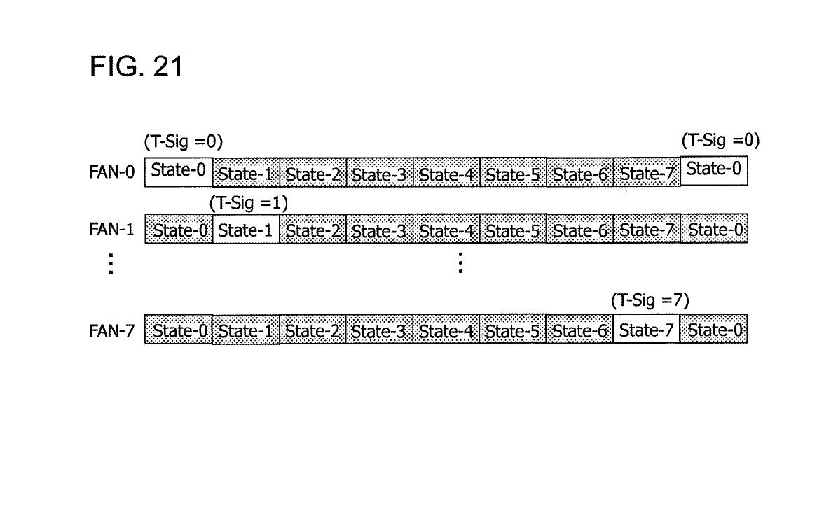

FIG. 21 is a diagram illustrating an operation performed by the control units 3-0 to 3-7 using the timing state setting signal T-sig according to the embodiment. As described above, varying the setting based on the timing state setting signal T-sig among the fans allows the start timings for the coil currents in the fans to be adjusted to different timing states State. Thus, the peak currents of the coil currents are restrained from overlapping.

In the example in FIG. 21, the fan FAN-0 is set to State-0, the fan FAN-1 is set to State-1, and the fan FAN-7 is set to State-7. Setting different timing states for the plurality of fans in this manner allows the generation timings for the peak currents of the coil currents to be distributed, enabling possible overlapping of the generation timings to be suppressed. Even when there is a mismatch in the phase and frequency of the clock CLK among the fans, the number of overlaps of the peak currents of the coil currents will be reasonably suppressed because the timing states of the fans are periodically reset in accordance with the synchronous signal C-sig.

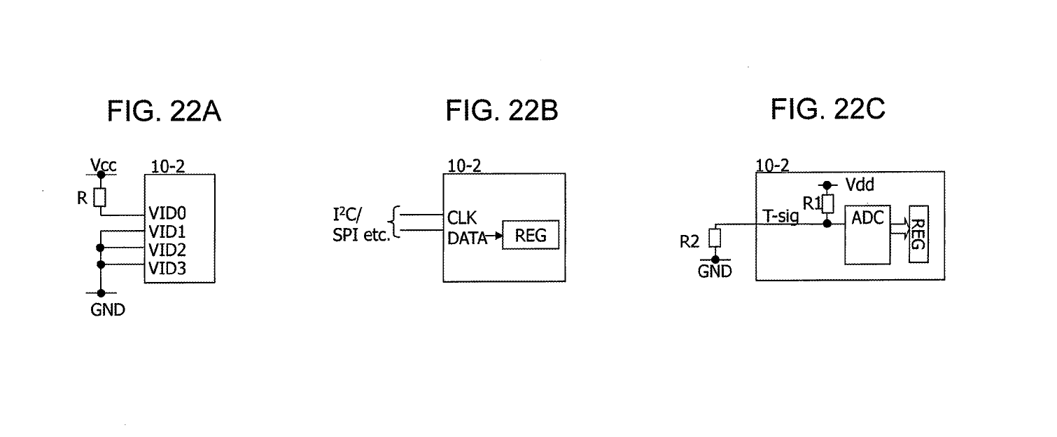

FIG. 22A to FIG. 22C are diagrams illustrating examples of a method for setting the timing state setting signal T-sig for the additional motor control circuit 10-2. FIG. 22A illustrates that the timing state setting signal T-sig is set by inputting an H level (power supply Vcc potential) or an L level (GND potential) to a 4-bit input VID0-3 of the additional motor control circuit 10-2. FIG. 22B illustrates that the timing state setting signal T-sig is set in a built-in register REG by inputting, through a serial interface such as I²C or SPI, a multiple-bit signal providing the timing state setting signal T-sig, using 1-bit data DATA in synchronism with the clock CLK. FIG. 22C illustrates that the resistance value of an external resistor R2 is changed so that a partial voltage resulting from a built-in resistor R1 can be input to the additional motor control circuit 10-2. The input partial voltage is converted into a digital value by an ADC, and the digital value is set in the built-in register REG.

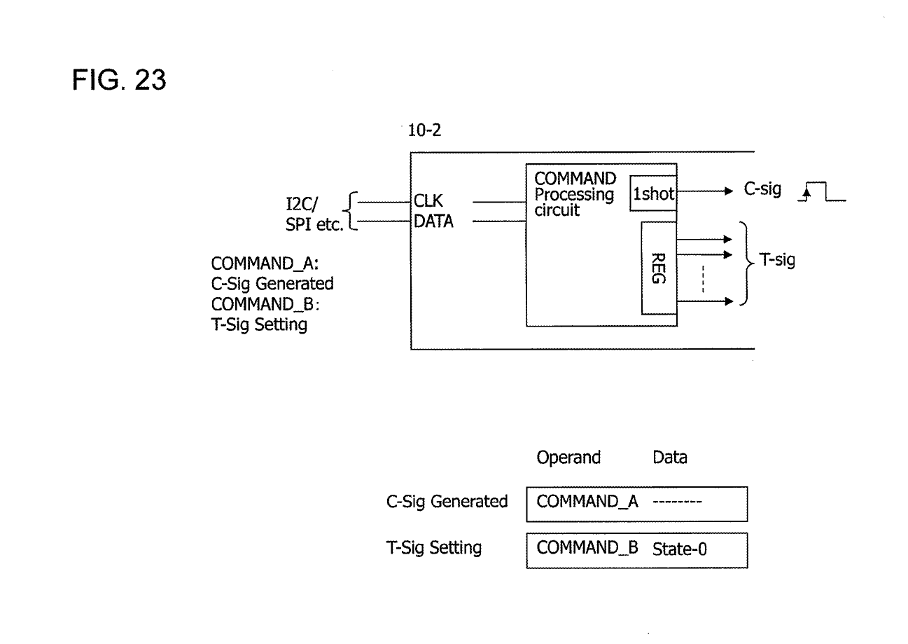

FIG. 23 is a diagram illustrating an example of a method for inputting the synchronous signal C-sig to the additional motor control circuit 10-2 and setting the timing state setting signal T-sig. In the example in FIG. 23, in use of I²C or SPI, the synchronous signal C-sig is generated or the setting signal T-sig is set by inputting a command A or a command B using 1-bit data DATA in synchronism with the clock CLK. The additional motor control circuit 10-2 includes a built-in command processing circuit. The additional motor control circuit 10-2 uses a one-shot circuit to generate a synchronous signal C-sig upon detecting the input of the command A, and stores the timing state of a data section of the command B in the internal register REG upon detecting the input of the command B.

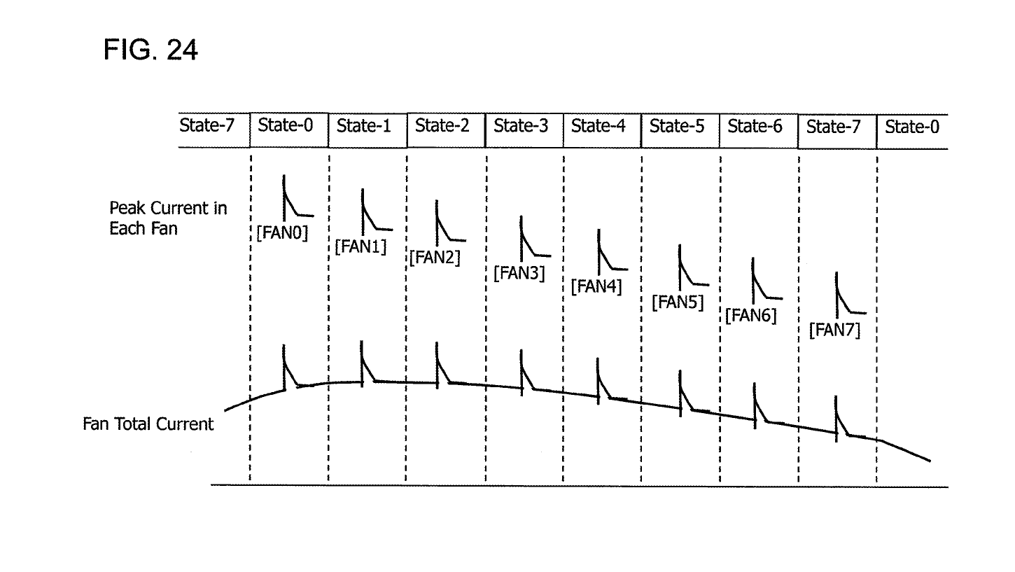

FIG. 24 is a diagram illustrating the fan current provided by the motor control apparatus according to the embodiment. The motor control apparatus distributes the generation timings for the peak currents in the plurality of fans FAN-0 to FAN-7 among eight timing states State0 to State7. As a result, the distribution of the peak currents suppresses the peak value of the total current of the motor currents in the eight fans.

### Second Embodiment

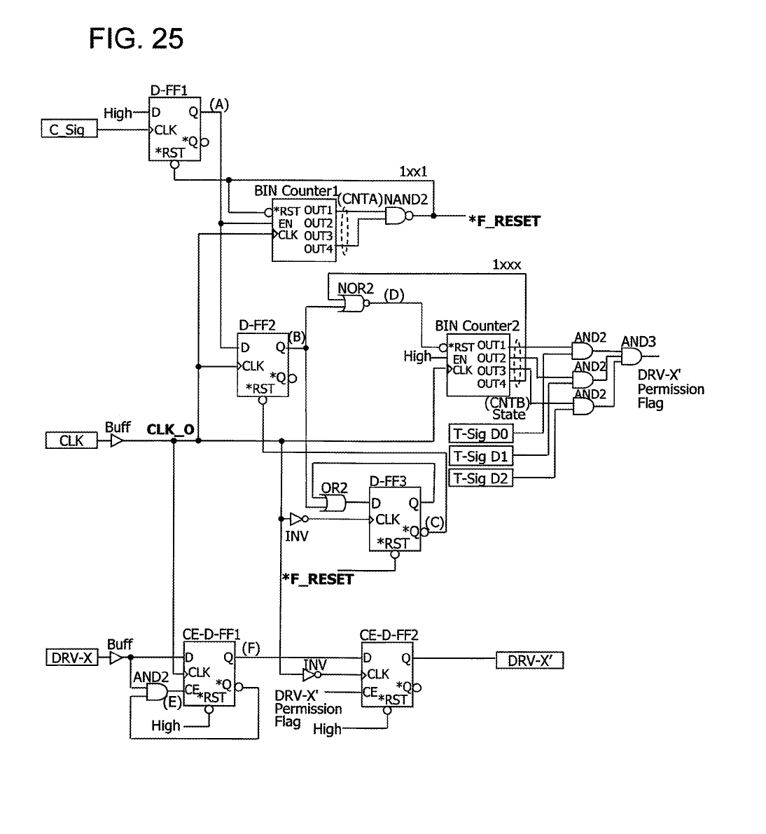

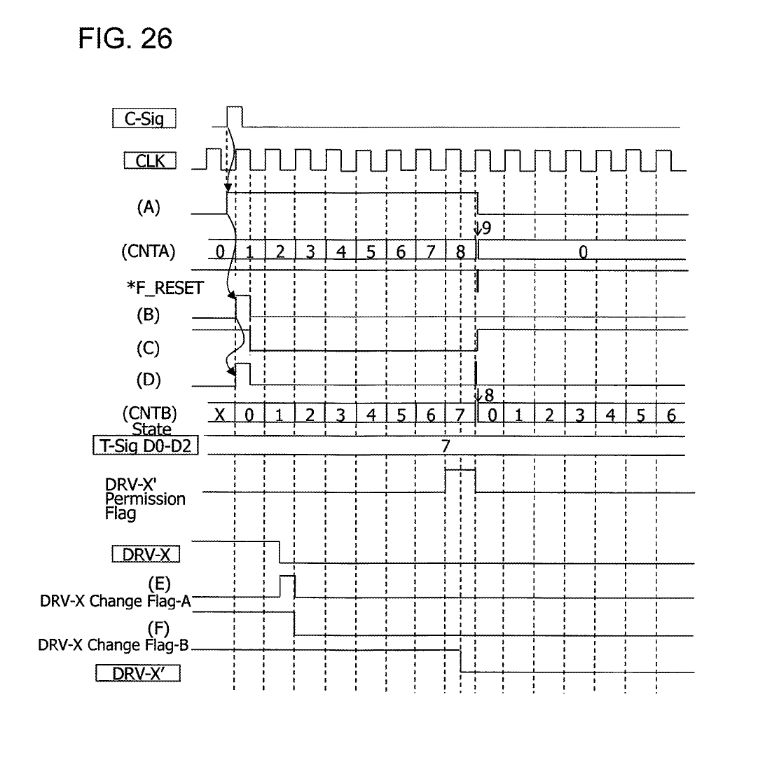

FIG. 25 is a circuit diagram of the additional motor control circuit 10-2 according to a second embodiment. Furthermore, FIG. 26 is a timing chart illustrating an operation of an additional motor control circuit 10-2. The operation of the additional motor control circuit 10-2 in FIG. 25 is the same as the operation according to the first embodiment. However, the additional motor control circuit 10-2 in FIG. 25 is a dedicated hardware circuit instead of a microcomputer.

The additional motor control circuit 10-2 in FIG. 25 has a flip-flop D-FF, a CE flip-flop CE-D-FF, a counter BIN_Counter, and a NAND gate NAND, a NOR gate NOR, an AND gate AND, and an inverter INV. The flip flop D-FF resets an output Q to L and resets an output *Q to H when a reset terminal *RST=L, and latches an input D at a rising edge of a clock CLK while *RST=H. The CE flip-flop CE-D-FF further maintains a previous latch state even at a rising edge of the clock CLK when a chip enable terminal CE=L and *RST=H. The counter BIN_Counter resets all of 4-bit outputs OUT1 to OUT4 to L when the reset *RST=L, holds the previous state when *RST=H and an enable terminal EN=L, and increments a count value by +1 in synchronism with a rising edge of the clock CLK when *RST=H and EN=H.

The additional motor control circuit 10-2 has a second counter BIN_Counter2 that increments the count value by +1 to generate an internal timing state, in response to a rising edge of the clock CLK. When the counter value in the second counter BIN_Counter2 is “1000=8”, the second counter BIN_Counter2 is reset to “0000” when a signal (D) is set to the L level via NOR2. The second timer BIN_Counter2 is also reset in accordance with the H level of a signal (B) resulting from the H level of a signal (A) associated with latching of a rising edge of a synchronous signal C-sig in the first flip-flop D-FF1. Then, when the counter value CNTB (the last three digits are indicative of the timing state) in the second counter BIN_Counter2 is equal to the value of the timing state setting signal T-sig, a driving signal DRV-X′ permission flag adjusted by AND2 and AND3 is set to the H level.

Furthermore, a change in an input driving signal DRV-X sets the output (E) of AND2 to the H level, and the direction of the change in the input driving signal DRV-X (from L to H or from H to L) is latched by the first CE flip-flop CE-D-FF1. Subsequently, at a timing when the adjusted driving signal DRV-X′ permission flag is set to the H level, the second CE flip-flop CE-D-FF2 latches the direction of the change in the adjusted driving signal DRV-X′ to output the adjusted driving signal DRV-X′. A first flip-flop D-FF1 and a second flip-flop D-FF2 convert a rising edge of the synchronous signal C-sig into the pulse signal (B) that synchronizes with the internal clock CLK. Furthermore, a first counter BIN_Counter1 maintains the H level state of the signal (A) corresponding to the state loop-back flag until the counter value in the first counter BIN_Counter1 reaches “1001=9”. This inhibits a subsequent erroneous synchronous signal C-sig from being latched.

Specific operations are as described below.

First, a rising edge of the synchronous signal C-sig is latched by the first flip-flop D-FF1 to set the signal (A) to the H level. While the signal (A) is at the H level, the count value CNTA in the first counter BIN_Counter1 is incremented in synchronism with the CLK. When the count value reaches the maximum value of 9, a reset signal *F_RESET of L level is generated to set the signal (A) to the L level. This prevents a possible situation where an synchronous signal C-sig erroneously generated before the count value CNTA reaches the maximum value of 9 changes the output (A) of the first flip-flop D-FF1. Such a synchronous signal C-sig is substantially neglected.

When the signal (A) is set to the H level, the second flip-flop D-FF2 latches the H level of the signal (A) at a rising edge of the CLK to set the signal (B) to the H level. The third flip-flop D-FF3 latches the H level of the signal (B) at a falling edge of the CLK to set a signal (C) to the L level. Then, the flip-flop D-FF2 outputting the signal (B) is reset to set the signal (B) to the L level. Thus, the synchronous signal C-sig is converted, in synchronism with the CLK, into a pulse (B) with a pulse width equal to the pulse width of the CLK.

When the reset signal *F_RESET of L level is generated, the third flip-flop D-FF3 is reset to set the signal (C) to the H level. The reset state of the second flip-flop D-FF2 is cancelled so as to latch the H level of the signal (A) by a subsequently generated new synchronous signal C-sig and enable the pulse of the signal (B) to be generated. Thus, the signal (C) corresponds to the above-described state loop-back flag.

The second counter BIN Counter2 increments the State in synchronism with the CLK. When an output CNTB from the second counter BIN Counter2 reaches the maximum value of 8 or the signal (B) into which the synchronous signal C-sig is converted in accordance with a timing of the internal clock CLK is set to the H level, the output CNTB of the second counter BIN Counter2 is synchronously reset via NOR2.

Then, when the State of the output CNTB of the second counter BIN Counter2 is equal to the set value of T-sig (3 bits), the adjusted driving signal DRV-X′ permission flag is set to the H level. The timing chart illustrates that the adjusted driving signal DRV-X′ permission flag is at the H level when the counter output CNTB is 7.

When the input driving signal DRV-X changes, a signal (E) is set to the H level to enable the first CE flip-flop CE-D-FF1. At the next rising edge of the CLK, the L level of the input driving signal DRV-X, into which the H level has been changed, is latched to set an output signal (F) to the L level. The signal (E) corresponds to a DRV-X change Flag-A, and the signal (F) corresponds to a DRV-X change Flag-B.

Finally, while the adjusted driving signal DRV-X′ permission flag is at the H level, the second CE flip-flop CE-D-FF2 is enabled to latch the L level of the signal (F) corresponding to the DRV-X change Flag-B in synchronism with a falling edge of the clock CLK. Thus, the adjusted driving signal DRV-X′ is set to the L level.

As described above, the additional motor control circuit 10-2 is also implemented using a hardware circuit.

As described above, according to the embodiment, the peak current, that is, a coil inrush current, is restrained from being generated at the same timing among a plurality of fans, allowing the peak value of the total current of the fan currents to be suppressed. Thus, a power supply apparatus for an information processing apparatus with a plurality of fans can be miniaturized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A motor control apparatus that controls a plurality of motors each including a plurality of coils,
the motor control apparatus comprising:
a plurality of coil current driving signal generation apparatuses each provided for a corresponding one of control-target controlled motors of the plurality of motors to generate, at a first time interval, a plurality of coil current driving signals supplied to the plurality of coils in the controlled motor, wherein
each of the plurality of coil current driving signal generation apparatuses includes:
a timing state generation unit that cyclically generates a plurality of timing states at a period of a second time, which is shorter than the first time interval; and
a coil current driving signal output unit that outputs the plurality of coil current driving signals to the controlled motor at a timing when the timing state generated by the timing state generation unit matches an assigned timing state assigned to the controlled motor.

2. The motor control apparatus according to claim 1, further comprising:
a synchronous signal generation apparatus that generates and supplies a synchronous signal to the plurality of coil current driving signal generation apparatuses, wherein
the plurality of coil current driving signal generation apparatuses generate or are supplied with different clocks respectively, and
the timing state generation unit cyclically generates the plurality of timing states at a period of the second time in synchronism with the clock, and resets the timing states in synchronism with the synchronous signal.

3. The motor control apparatus according to claim 2, wherein the synchronous signal generation apparatus generates the synchronous signal at a third time interval, which is longer than the second time.

4. The motor control apparatus according to claim 1, wherein
each of the plurality of coils consumes a coil current during a predetermined driving time in response to the corresponding coil current driving signal, and
the coil current includes a peak current generated for a time shorter than a time of the timing state at a start of the coil current driving signal, and a driving current generated for a time longer than the time of the timing state after the peak current and having a magnitude that is smaller than a magnitude of the peak current and that corresponds to a rotation speed of the motor.

5. A motor control method using a motor control apparatus that controls a plurality of motors each including a plurality of coils, the motor control apparatus including a plurality of coil current driving signal generation apparatuses each provided for a corresponding one of control-target controlled motors of the plurality of motors to generate, at a first time interval, a plurality of coil current driving signals supplied to the plurality of coils in the controlled motor,
the method operating each of the plurality of coil current driving signal generation apparatuses to execute:
cyclically generating a plurality of timing states at a period of a second time, which is shorter than the first time interval; and
outputting the plurality of coil current driving signals to the controlled motor at a timing when the timing state generated matches an assigned timing state assigned to the controlled motor.

6. The motor control method according to claim 5, wherein
the plurality of coil current driving signal generation apparatuses generate or are supplied with different clocks respectively, and
a synchronous signal generated commonly for the plurality of coil current driving signal generation apparatuses is supplied to the plurality of coil current driving signal generation apparatuses, and
in the generation of the timing states, cyclically generating the plurality of timing states at a period of the second time in synchronism with the clock, and the timing states are reset in synchronism with the synchronous signal.

7. The motor control method according to claim 6, wherein the synchronous signal is generated at a third time interval, which is longer than the second time.
